(19) United States
(12) Patent Application Publication
(10) Pub. No.: US 2023/0334454 A1
(43) Pub. Date: Oct. 19, 2023

(54) Mobile Vending Structure

(71) Applicant: Ronnie Boswell, Muskogee, OK (US)

(72) Inventor: Ronnie Boswell, Muskogee, OK (US)

(21) Appl. No.: 17/722,316

(22) Filed: Apr. 16, 2022

(51) Int. Cl. G06Q 20/18; G07F 13/04

(52) U.S. Cl. CPC G06Q 20/18; G07F 13/04

(57) ABSTRACT

A vending structure comprising: exterior walls, a roof and a floor all defining a main structure; at least one transaction window; at least one ATM; at least one sign; a safe room defined within the structure with heightened security features including a secure entry door; electronic systems including at least one camera, an internet connection, at least one point of sale system, and at least one power distribution system. The structure may include a second level removably mounted on top of the main structure, the second level serving as a customer lounge for consuming products vended on the main floor. The second level preferably includes a vent means for venting fumes from the second level comprising either floor grates up through which at least one fan blows air or a vent hood with a powered fan drawing fumes up and away from the second level.

### RELATED APPLICATIONS

Applicant claims benefit pursuant to 35 U.S.C. § 119 and herby incorporate by reference provisional patent application No. 63/176,033 for a “secure, movable vending structure,” filed Apr. 16, 2021.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood these statements are to be read in this light, and not as admissions of prior art.

The present invention generally relates to vending structures. In particular, the invention relates to movable structures for vending herbal products, in environments where a substantial volume of cash transactions are expected.

Vending structures provide concessions for food, beverages and other commonly purchased products at entertainment venues. Generally, vending structures are moveable and commonly setup at temporary locations. Vending structures come in various sizes and shapes, and often provide other features for customer convenience. Additionally, vending structures may be incorporated with larger structures to offer less commonly associated consumer products.

The layout and features of such vending structures vary according to a variety of factors, depending on the nature of the products or services being sold, the place where they are to be used, the distances over which the structures may be transported, and the need for ease and speed of setup.

Movable vending structures range from carts vending hot dogs on the street to large semi-trailers. See, for example, U.S. Pat. No. 3,748,437 for a mobile food concession cart of the type commonly seen on the street vending hot dogs. Most vending structures are trailers, where the structure is permanently mounted on wheels with a means for affixing the structure to a vehicle capable of towing it to a desired location. However, it is also known to provide mobile structures that must be loaded onto a separate trailer for transport. See, for example, U.S. Pat. No. 3,095,616 for a portable building and apparatus for the transportation and erection of the same.

As will be appreciated, vending structures are often transported from one location to another. Transportation from one venue to another can often be thousands of miles apart, consuming a considerable amount of time. It is desired that vending structures for entertainment venues be easy to maintain and provide for quick setup.

Space is an important limiting factor for the size of vending structures. First, space is limited by the area available for transportation. Second, space is limited by the area available at the temporary locations. To be readily moveable vending structures cannot exceed common carrier limitations. The cost of transportation is commonly proportional to size and weight. A structure that is too large may incur significant transportation costs, rending the business not profitable. Further, space may be relatively limited at entertainment venues as well. It is known that entertainment venues for festivals, concerts, and other entertainment events are held at temporary locations. There is limited space with designated areas for food, promotional sales, and vending of other products. In many cases there are multiple vending structures sharing the designated areas at a venue. Thus, it is desired to maximize the limited space available at the entertainment venues.

Due to the highly portable nature of vending structures security features are desired. Often times the vending structures provided for at entertainment venues handle high-volume of transactions. In particular, vending of herbal products vending structures handle high-volume cash transactions. Storing large quantities of cash places vending structures dealing in this nature as high targets for theft. Other times the vending structures are set up in advance of a public event, and the structure is left unattended for periods of time. The merchandise and products left unattended are susceptible to theft. Thus, it is desired to have heightened security features incorporated with the vending structures.

For the foregoing reasons, there is a need for a modular vending structure with security features for high-volume cash transactions at entertainment venues.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present invention are generally directed to vending structures that satisfy the need to be portable and provide secure transactions for high-volume cash transaction at entertainment venues. In one embodiment, the vending structure includes a main structure, a transaction window, a sign, an automated teller machine, a staircase and a safe room.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### DRAWINGS

These and other features, aspects, and advantages of the present invention will become better understood with regard to the following description, appended claims, and accompanying drawings where:

FIG. 1 is a front view of the vending structure with the optional second level included in accordance with an embodiment of the present disclosure;

FIG. 2 is a side view of the vending structure with the optional second level included;

FIG. 3 is a floor plan of the first story of the vending structure;

FIG. 4 is a perspective view of an alternate embodiment of the vending structure;

FIG. 5 is a top cross section view of the vending structure illustrating components designed to increase the security and insulating capacity of devices made from shipping containers; and

FIG. 6 is a perspective view of an alternate embodiment of the optional second level.

FIG. 7 is a side view of a slide-out rail embodiment for elevating and lowering the second level showing the rails in a deployed position.

FIG. 8 is a front view of the rail embodiment showing the rails in a stored position.

FIG. 9 is a detailed side view of the rails engaging with the support dog.

### DESCRIPTION

The present invention will now be described more fully hereinafter with reference to the accompanying drawings, which illustrate various embodiments of the invention. This invention, however, may be embodied in many different forms and should not be construed as limited to the illustrated embodiments set forth herein; rather, these embodiments are provided so that this disclosure will be thorough and complete, and will fully convey the scope of the invention to those skilled in the art.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the” and “said” are intended to mean that there are one or more of the elements. The terms “comprising,” “including,” “having,” and grammatical equivalents thereof are intended to be inclusive and mean that there may be additional elements other than the listed elements.

Moreover, any use of “top,” “bottom,” “above,” “below,” “left,” “right,” other directional terms, and variations of these terms is made for convenience, but does not require any particular orientation of the components.

“Automated teller machine” refers to is an electronic banking outlet that allows customers to complete basic transactions without the aid of a branch representative or teller.

“Ballistic glass” refers to a strong and optically transparent material that is particularly resistant to penetration by projectiles.

“POS terminal” refers to a device which interfaces with payment cards to make electronic funds transfers. The terminal typically consists of a secure keypad for entering PIN, a screen, a means of capturing information from payments cards and a network connection to access the payment network for authorization.

“Security alarm system” refers to a system designed to detect intrusion, such as unauthorized entry, into a building or other areas such as a locker, or safe room. Security alarms generally protect against burglary or property damage, as well as personal protection against intruders. Security alarm systems may serve a single purpose, or may be combined with various devices for combination protection.

“HVAC” refers to heating, ventilation, and air conditioning technologies to control the temperature, humidity, and purity of the air in an enclosed space.

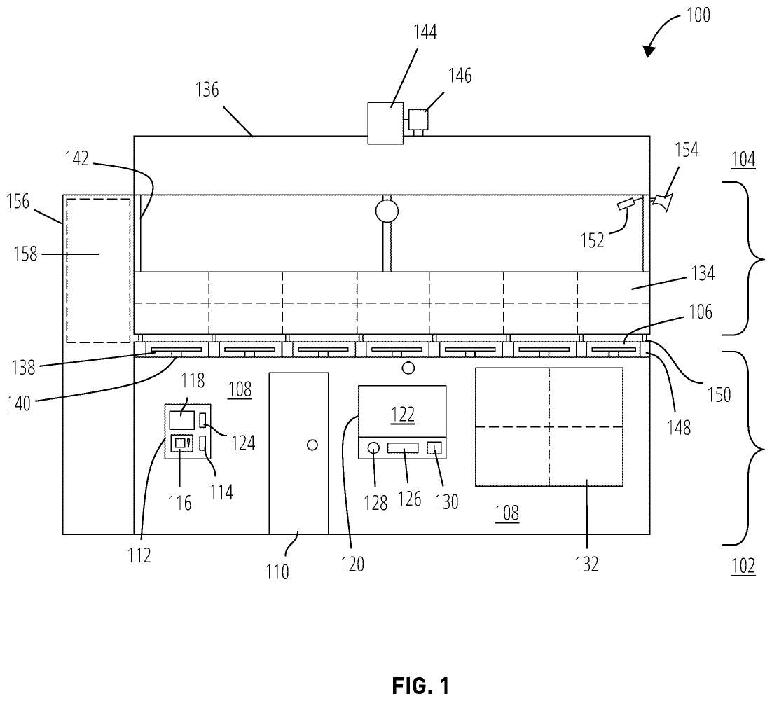

Turning to the present figures, FIG. 1 is a front view of the portable vending structure 100 with bot a first level 102 and the optional second level 104. The first level 102 preferably includes a door 110, automated teller machine 112, a transaction window 120, and a sign 132. The second level 104 preferably includes at least one vent fans 138, a roof 136, at least one camera 152, at least one speaker 154, and an upper display 134. Affixed to the left of the vending structure 100 is an elevator shaft 156 with an elevator 158.

Present on the first level 102 is a wall 108, of the vending structure 100. A door 110 is defined in the wall 108. A sign 132 is provided on the wall 108, for use to display available products and pricing or other information. In a preferred embodiment the sign 132 is an electronic display; however, it will be appreciated that the sign may either be a printed or painted in other embodiments, as will be discussed in more detail later. The sign 132 as shown in FIG. 1 has dashed lines indicating separate monitors which are unified together to create a larger unitary display that appears as one screen. Preferably, the opposite side of the vending structure 100 replicates the elements described above (other than the door 110 for which it is anticipated there will not be more than one on a side).

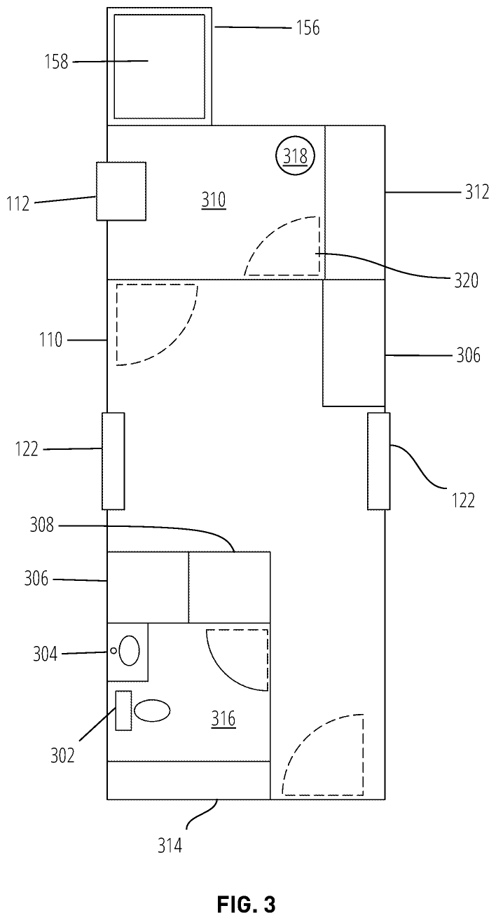

An automated teller machine 112 is also mounted on the wall 108 of the vending structure 100. The automated teller machine 112 projects back into a safe room 310 (FIG. 3) that will be discussed below. The automated teller machine 112 has a card reader 114 for a customer to insert their payment card such as a credit card, debit card or the like. It has a teller camera 124 to monitor security of the transactions. A keypad and dispenser 116 is present to allow entry of data such a pin and dispensing of cash. The automated teller machine 112 has a screen 118 to display information to a customer.

A transaction window 120 is also placed within the wall 108 of the vending structure 100. The transaction window 120 may have a transaction tray 126, transaction speaker 128 and a transaction data port 130 for sale of products. The transaction tray 126 allows a worker to pass products out to a customer and the customer to pass cash or other payment to the worker. The glass 122 of the transaction window 120 is preferably ballistic glass for security. A transaction data port 130 is defined on the outside of the transaction window 120. The transaction data port 130 may include a removable or fixed POS terminal. In a preferred embodiment, for unmanned operation, the transaction data port 130 includes the ability to read a picture identification from the customer and to use a camera integrated with the transaction window 120 to face match the customer with the picture on the identification card. There is a transaction speaker 128 to facilitate communication between the customer and a worker.

The optional second level 104 of the vending structure 100 is intended to be used as a lounge for customers. In the lounge, customers can consume the herbal products preferably dispensed from the vending structure 100. In a preferred embodiment of the vending structure 100, the second level 104 has substantially the same footprint as the first story for transportation. The second level 104 is intended to be removable such that, when the vending structure 100 is transported, the first and second level 104 are separated so the height of the vending structure does not exceed overpasses presenting problems for transportation. Thus, the second level 104 is supported above the first level 102 of the vending structure 100 by a series of stake receivers 148. The stake receivers 148 are preferably mounted on an upper exterior periphery of the vending structure 100. The second level 106 is preferably a grate which allows airflow therethrough. The second level 106 may be supported by a series of stakes 150 engaging the stake receivers 148. The stakes 150 are preferably affixed to a series of upper displays 134. The upper displays 134 have sufficient structural integrity to serve as a safety railing to keep customers in the second level 104 from falling out. The upper displays 134 in a preferred embodiment is a fixed sign. It will be appreciated, however, that the upper display 134 may be painted or printed or an electronic display. Again, hatched lines of the upper display 134 are shown indicating separate displays that are unified together to make a contiguous display at second level 104 of the vending structure 100.

To provide enhanced ventilation and cooling, a series of fans 138 may be mounted on top of the first level 102 of the vending structure 100. The fan motor 140 may drive the fans 138 to push air up through the grates providing both ventilation of any smoke from products consumed on the second level 104 as well as pushing it up towards a higher altitude where it is less likely to be detected by persons passing by the vending structure 100. As will be discussed, in an alternate embodiment of the vending structure 100 the fans 138 may be mounted to the upper portion of the second level 104.

On the second level 104, there is preferably provided a series of speakers 154 and cameras 152. The speakers 154 allow for both music for the customers as well as addressing the public. Announcements or advertisements may be aired through the speaker 154 to both the customers in the lounge and those nearby outside.

A camera 152 is mounted above the transaction window 120. There may also or instead be a camera 152 mounted within the body of the transaction window 120. Multiple cameras 152 are placed around the vending structure 100 for security given the high-value products and high-volume of cash handled during the course of business.

A series of posts 142 support a roof 136. The roof 136 may be pitched and have at a center point a vent stack 144. The vent stack 144 has a fan disposed therein driving by a vent motor 146 to pull air from underneath the roof 136 and vent it upwardly and out and away from the vending structure 100. It will be appreciated that the roof 136 may be selected from other varieties such as one or more cloth sails, a pitched roof, retractable or none at all.

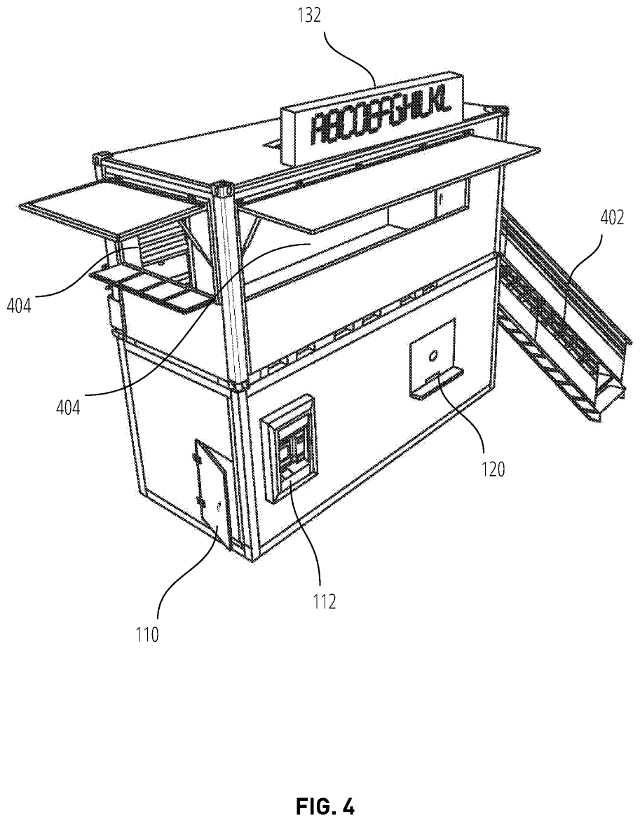

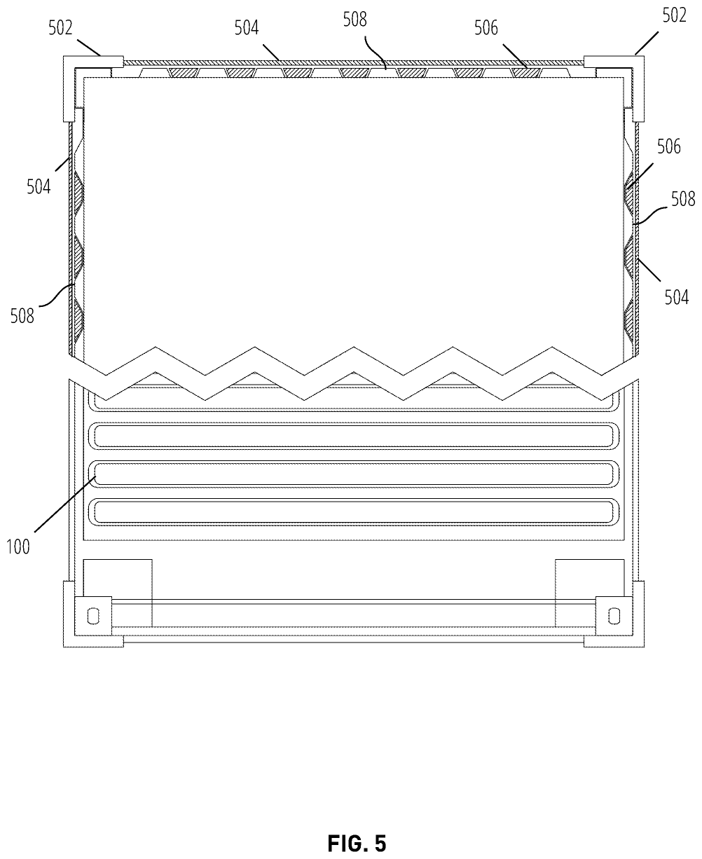

A means of allowing customers to get to a second level of the vending structure 100 is provided. As shown, an elevator shaft 156 is mounted at an end of the vending structure 100. Disposed within the elevator shaft 156 is an elevator 158 for receiving at least one person. The benefit of an elevator 158 is that it provides controlled access to the second level. The elevator 158 can be locked as needed to prevent unwanted access to the second level 106 such as when capacity has been reached regarding the number of people allowed to enter. But it will be appreciated that an alternate means of allowing customers to reach the second level 104 of the vending structure 100, such as a staircase 402 (as shown in FIG. 4).

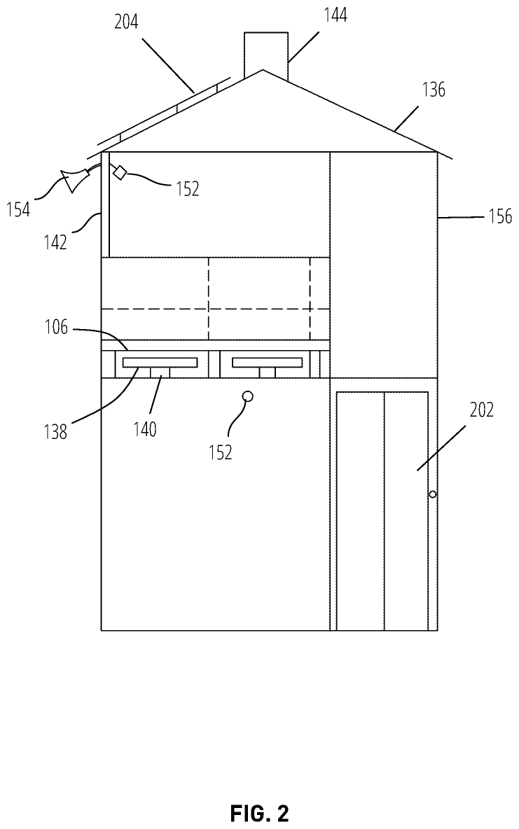

FIG. 2 is a side view of the vending structure 100 in accordance with one embodiment. The elevator shaft 156 can be seen from the right end of the vending structure 100, and the elevator doors 202 mounted at the lower level thereof. Similar elevator doors 202 are present for egress on the second level 104.

The upper display 134 is depicted to wrap around to the side of the vending structure 100. As shown are surveillance cameras 152.

Additionally, for off-grid use, there may be solar panels 204 disposed on the roof 136.

FIG. 3 generally illustrates a floor plan of the first level 102 of the vending structure 100. At a first end adjacent to the elevator shaft 156 is a safe room 310. The safe room 310 is a more secure portion of the vending structure 100 which includes thicker or at least more solid walls. It is expected that the safe room 310 will contain additional inventory as well as cash. There is preferably a security entry door such as a safe door 320 for entry to and from the safe room 310 for security. Furthermore, there is preferably a locker 312 which may serve as a secondary safe disposed within the safe room 310. The safe room 310 and the locker 312 may be equipped with a security alarm system 318. It will be appreciated that the security alarm system 318 may be comprised of various security devices, such as a motion sensor or door sensor.

The automated teller machine 112 projects inwardly into the safe room 310. Additional cash can be stored in the safe room 310 and reloaded securely from within the safe room 310 into the automated teller machine 112.

The floor plan of the second level 104 is expected to be substantially open. It is anticipated that seating may be provided for patrons. Further it may be desirable to provide an on-site restroom. Otherwise, it is not expected that there will be any other structures or dividers on the optional second level 104.

Outside of the safe room 310 is the vending portion of the vending structure 100. It includes a first storage 306 and, as shown, a second storage 306. A number of storages 306 may be provided depending on the configuration. A refrigerator 308 is preferably provided for maintaining cold products in that condition for dispensing to customers. There may be a bathroom 316 including a sink 304 and a toilet 302. In a preferred environment, the floor of the bathroom is elevated so that underneath it are, for example, storage tanks for gray water, fresh water, as well as possibly also batteries for operation of the unit off of the grid. Finally, as shown in FIG. 3, there may be product storage cabinet such as an equipment cabinet 314 which may be accessible from either inside the vending structure 100 or outside depending on preferences and security needs.

A plethora of electronics are provided including security, internet communication with central servers to facilitate automated teller machine and sales transactions as well as point-of-sale inventory control and the like. The power distribution system, electronics and any computers associated with them may be disposed within the safe room 310 or, they may be disposed, for example in equipment cabinet 314. It is important to provide sufficient ventilation and cooling for the computer and electronic equipment to operate properly.

An HVAC system is provided for the operating portion of the vending structure in which workers sit. The ventilation system maintains appropriate temperature as well as providing fresh air. The herbal products may have significant odors, so the fresh air is desirable to ensure the health and wellness of workers.

Each storage 306 may have its own ventilation. Fresh air can be drawn into the cabinet and vented outside the vending structure 100 so that the products are stored in an environment that minimizes the odors emanating into the operational space where the workers are doing their jobs.

FIG. 4 is a perspective view of an alternate embodiment of the vending structure 100 featuring a staircase 402. This embodiment shows a second level of a type preferably made from a modified shipping container.

The second level 104 is essentially one unit and the first level 102 is a separate unit. Both units are substantially the similar size and shape for portability. To transport the vending structure 100 from one location to another, the units must be disassembled as noted. The elevator shaft 156 (FIG. 1) and optional staircase 402, as depicted in FIG. 4, are separate structures.

In an alternate embodiment, the sign 132 may be mounted at the top of the second level 104.

For disassembly and transportation the elevator shaft 156 is preferably removed and, for example, transported inside of the second level 104. The sign 132 are also removed from the vending structure 100 and stored within the second level 104 for transport. Depending on its size and weight, the second level 104 may be disassembled in pieces for easier raising and lowering, and to facilitate them being more easily transported. To facilitate disassembly, a crane may be removably mounted on the structure. The crane may be mounted within one or more of the stake receivers 148.

FIG. 5 is a top cross section view of the vending structure illustrating corner brackets 502, wall panels 504, and insulation 506 which are designed to increase the security and insulating capacity of vending structures 100 made from shipping containers having corrugated walls 508. The corner bracket 502 mounted to the corner of the vending structure 100 and the wall panel 504 is attached to the corner bracket 502. Insulation 506 is fitted within the corrugated wall 508 of the vending structure 100 that is preferably made from shipping containers. The corner bracket 502 serves as an attachment point for the wall panel 504. The wall panel 504 retains the insulation 506 in a fixed position. The insulation 506 provides thermal and sonic resistance and increases insulation value of the vending structure 100. The insulation 506 can be removably affixed or attached to the vending structure 100. The insulation 506 can be of different kinds such as spray or loose-fill. Also, it can be individual insulation pieces adapted to be received within the corrugations, or it can be a sheet of them joined together.

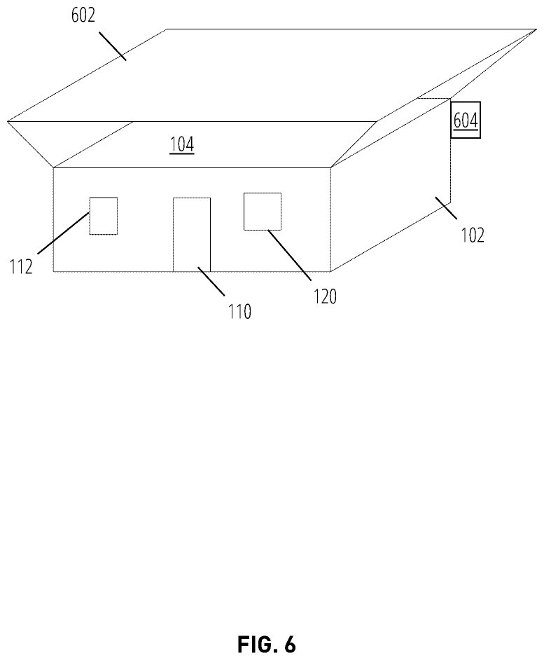

FIG. 6 is a perspective view of an alternate embodiment of the vending structure 100 with the optional second level 104 and a sail roof 602. The sail roof 602 is shown with a larger size than the footprint of the second level for extra shade and precipitation coverage. It will be appreciated that the sail 602 can be of different shapes, sizes and may be multiple sails unified. The sail 602 serves as a roof and provides shade coverage to the second level 104. The sail 602 is preferably removably affixed the second level 104 for removal when weather permit and transportation to and from and entertainment venue. A winch 604 can be used to retract the sail 602, whether powered or manual.

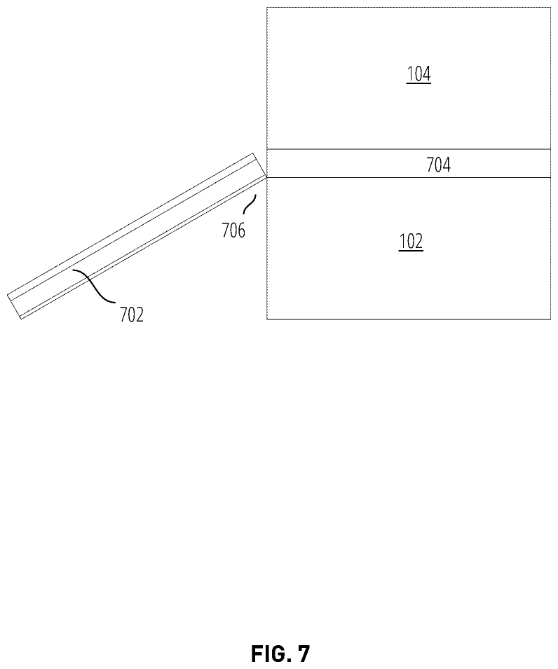

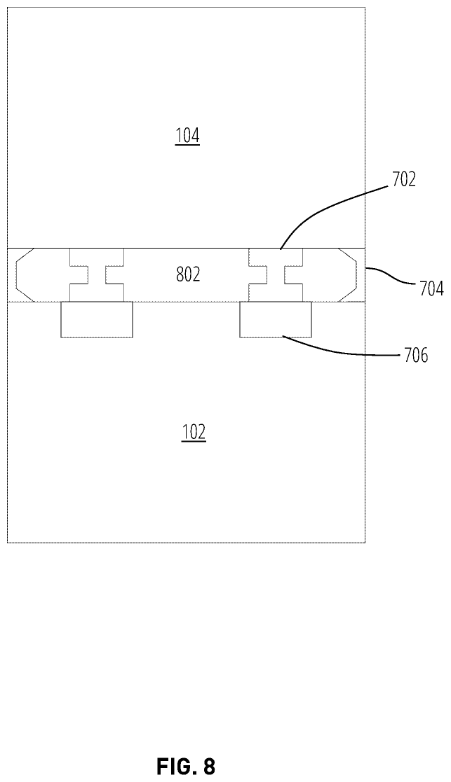

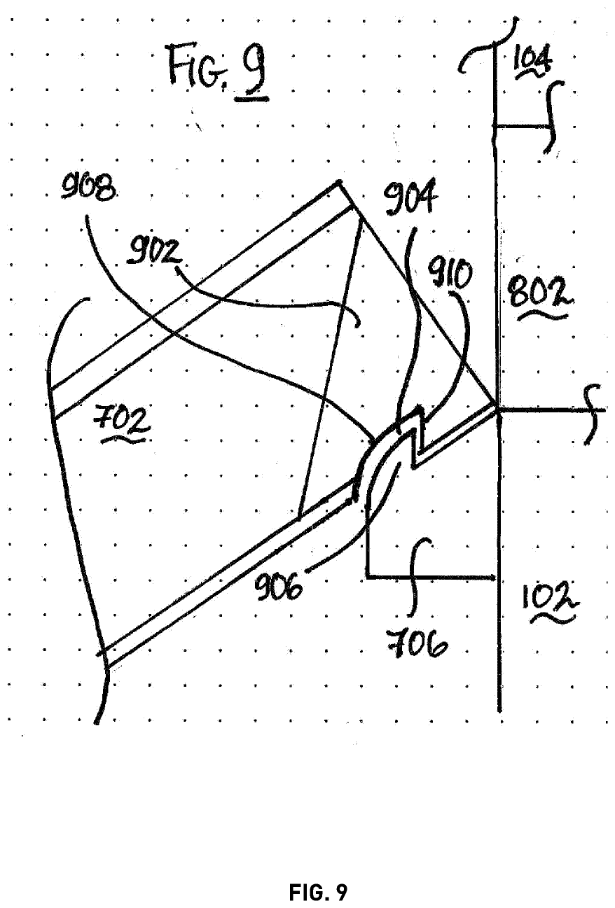

FIG. 7-9 illustrate a slide-out rail embodiment for lifting and lowering the second level 104 onto the lower level 102. FIG. 7 is a side view showing the rails 702 in a deployed position. In a stored position, the rails 702 slide into a rail storage area seen in FIG. 8. The second level 104 rests on side rails 704. When deployed, the rails 702 releasably engage support dogs 706.

FIG. 8 is a front view of the rail embodiment showing the rails 702 in a stored position. In this view, the rail storage area 802 can be seen. The second level 104 is mounted on top of the first level 102 and is supported by the rails 702.

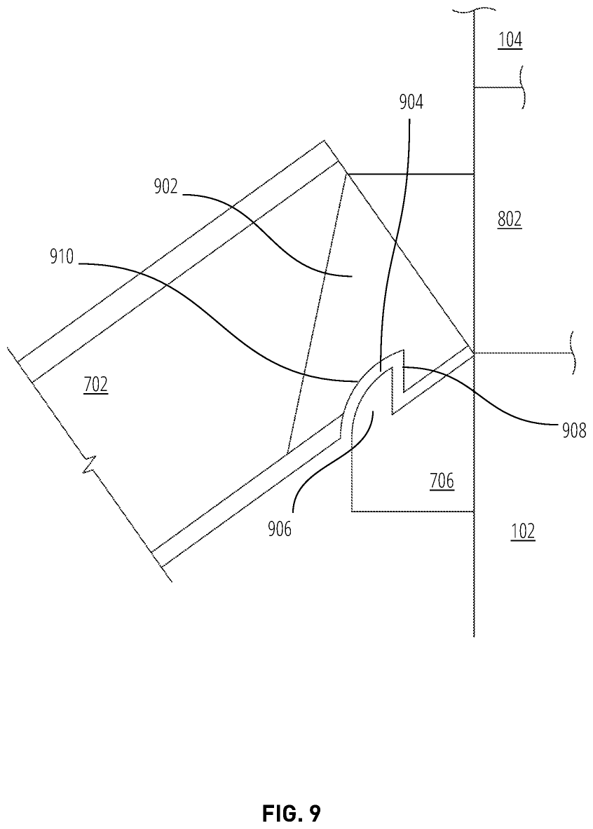

FIG. 9 is a detailed side view of the rails 702 engaging with the support dog 706. There is preferably a reinforcing plate 902 affixed to an end of the rails 702. Cut out of the reinforcing plate 902 is a receiver 904 having a curved inner edge 908 and defining a rail tooth 910. Similarly, there is a dog tooth 906 adapted to engage the rail tooth 910. A winch can be used to pull the second level 104 along the rails 702 to either lift them onto the first level 102 or lower it down. Preferably, support dogs 706 and cooperating receivers are provided at both ends of the rails 702 and of the first level 102. This embodiment allows the second level 104 to be mounted without the use of a crane.

Although the present invention has been described in considerable detail with reference to certain preferred versions thereof, other versions are possible. For example, the bolt-on closure of the clamp can be a hydraulic system. Therefore, the spirit and scope of the appended claims should not be limited to the description of the preferred versions contained herein. Any element in a claim that does not explicitly state “means for” performing a specified function, or “step for” performing a specific function, is not to be interpreted as a “means” or “step” clause as specified in 35 U.S.C. § 112, ¶ 6. In particular, the use of “step of” in the claims herein is not intended to invoke the provisions of 35 U.S.C. § 112, ¶ 6.

What is claimed is:

1. A mobile vending structure comprising:
a. a main structure having a floor, sidewalls and a roof;
b. at least one transaction window mounted in a sidewall, the transaction window having at least a portal through which articles can be securely transmitted;
c. a safe room adapted for secure storage of valuables;
d. at least one automated teller machine mounted in a sidewall;
e. an electronic system having —
i. at least one camera,
ii. an internet connection,
iii. a point of sale system,
iv. a security system, and
v. a power distribution system.

2. The structure of claim 1 wherein the automated teller machine projects backwardly into the safe room.

3. The mobile vending structure of claim 1 further having an electronic sign adjacent to a transaction window for displaying available products.

4. The mobile vending structure of claim 1, further comprising a second level lounge removably mounted on top of the of the main structure, the lounge comprising:
a. an access means for allowing customers to ascend to the lounge; and
b. a railing to prevent customers from falling out of the lounge.

5. The mobile vending structure of claim 1, the access means selected from stairs or an elevator.

6. The mobile vending structure of claim 5 where the lounge is covered with a roof.

7. The mobile vending structure of claim 6 where the roof is selected from pitched, flat, or fabric.

8. The mobile vending structure of claim 7 where the fabric roof has a footprint that is larger than a footprint of the second level.

9. The mobile vending structure of claim 1? further comprising a vent means for venting fumes from the second level.

10. The mobile vending structure of claim 9, the vent means comprising floor grates up through which at least one fan blows air.

11. The mobile vending structure of claim 10, the vent means comprising a vent hood with a powered fan drawing fumes up and away from the second level.

12. The mobile vending structure of claim 1 having a HVAC system to maintain a desirable temperature within the structure.

13. The mobile vending structure of claim 12 in which the HVAC system brings in fresh air and vents out air from within the structure.

14. The mobile vending structure of claim 1 in which at least one product storage cabinet is located in the structure.

15. The mobile vending structure of claim 14 where each product storage cabinet is supplied with fresh air and air from within the product storage cabinet is vented whereby vapors emanating from products stored in each product storage cabinet do not disperse into the structure.

16. The mobile vending structure of claim 1 having integrated video, point of sale and security systems communicate that via the Internet with at least one remote location.

17. The mobile vending structure of claim 1, where the second level is mounted on the first level by a mechanism selected from: winch and ramp combination or a crane.

18. The mobile vending structure of claim 17 having retractable rails upon which the second level may be raised or lowered and which, when not in a deployed position, are stored between the first and second levels.

19. The mobile vending structure of claim 1, the safe room comprising heightened physical security features including a security entry door and thicker walls.

20. The mobile vending structure of claim 1, the transaction window comprising ballistic resistant glass.

21. A mobile vending structure comprising:
a. a main structure having a floor, sidewalls and a roof, at least one transaction window mounted in a sidewall, the transaction window having at least a portal through which articles can be securely transmitted;
b. a safe room adapted for secure storage of valuables defined within the main structure;
c. at least one automated teller machine mounted in a sidewall projecting backwardly into the safe room;
d. an electronic sign adjacent to a transaction window for displaying available products;
e. a second level removably mounted on top of the main structure having a lounge, and an access means for allowing customers to ascend to the second level; and
f. an electronic system having—
i. at least one camera,
ii. an internet connection,
iii. a point of sale system,
iv. a security system, and
v. a power distribution system.
